(19) United States
(12) Patent Application Publication
(10) Pub. No.: US 2013/0222143 A1
(43) Pub. Date: Aug. 29, 2013

(54) SHELF ARRANGEMENT FOR FLUID DRAINAGE

(71) Applicant: Santiago J. Martinez, San Jose, CA (US)

(72) Inventor: Santiago J. Martinez, San Jose, CA (US)

(21) Appl. No.: 13/408,983

(22) Filed: Feb. 29, 2012

(51) Int. Cl. G08B 21/00; A47B 81/00

(52) U.S. Cl. 340/612; 211/71.01

(57) ABSTRACT

Discussed herein is a shelf assembly that allows efficient discharge and collection of fluids out of fluid containers. In embodiments, the shelf assembly includes one or more racks that allow for placement of fluid containers in an inverted position. The shelf assembly further includes a collecting tray adjacent to (e.g., below) each rack to collect the fluids dripping out of the racks. The collecting tray discharges the fluids from the tray to a discharge station via outlets and/or connecting spouts. The discharge station allows for collection of the discharged fluids and subsequent disposal of the discharge. Such disposal is in accordance with EPA or other local regulations.

### FIELD OF INVENTION

The present invention generally relates to shelf assemblies, specifically shelf assemblies that allow excess fluids to be drained from fluid containers, as described in the following sections.

### BACKGROUND OF THE INVENTION

Be it a modern and bustling city, or a rural village with limited access, automobiles and other such vehicles are the predominant sources of transportation for moving people and goods. A common and incidental feature of use of automobiles is the need for frequent servicing of the automobiles. It is commonplace for owners of vehicles to visit automobile service centers (hereafter “service centers”) for performing various maintenance and repair services for their vehicles. During such service visits, automobiles are usually flushed or replenished with a variety of fluids, including for example, engine oil, wiper fluids, coolant liquids, etc. The service centers typically purchase such fluids for use in servicing vehicles.

Consider an illustrative example where a service center technician is asked to replace the engine oil in a car. In a typical scenario, the technician would open a plastic container containing the engine oil supplied by a manufacturer and transfer the contents of the plastic container to the car's engine. Considering the nature and viscosity of the liquid in the plastic container, it is well known that at least trace quantities of the fluid (e.g., engine oil) remain in the container even after the technician makes an attempt to transfer the entire quantity to the automobile. The plastic container is then discarded either as trash or as a recyclable item as is the common practice for the service center. Such discarded containers, as discussed above, retain at least trace quantities of the fluid. Over time, even the trace amounts of fluids accumulate, causing substantial pile up of discarded fluids. It is well known that such fluids (e.g., engine oil or coolant liquids) contain toxic substances and present both environmental and health related hazards. Risks of the fluid build up entering local water supply sources and also the local food chain supply are considerable.

World over, various environment protection agencies (e.g., U.S. E.P.A) impose restrictions to mitigate the hazards associated with such fluid build up. One common restriction is, for example, that the service centers drain out the fluids completely from their respective containers before discarding such containers. However, service centers are typically ill-equipped with mechanisms to ensure a maximum amount of drainage of the leftover fluids. Washing out the containers is not an option, as a wash of the containers presents the same risk of the fluids entering local water supply sources. Some service centers then employ people to vigorously “shake out” contents remaining in the container prior to discarding the container. Such a vigorous shake out would still cause the fluids to be wasted or contribute to the pollution risk. In some cases, the technician may allow the container to be placed up-side down to allow excess fluids to drain out completely, but the technician typically lacks a sustainable and efficient arrangement for allowing such drainage. Accordingly, service centers are unable to adapt to such EPA or other governmental regulations regarding fluid draining, and consequently stay in risk of being fined or reprimanded for discarding containers that still contain even trace amounts of fluids. Therefore, an arrangement that would allow efficient and easy drainage of such excess fluids would be very beneficial.

Overall, the examples herein of some prior or related systems and their associated limitations are intended to be illustrative and not exclusive. Other limitations of existing or prior systems will become apparent to those of skill in the art upon reading the following Detailed Description.

### SUMMARY OF THE DESCRIPTION

Discussed herein is a shelf assembly that allows efficient discharge and collection of fluids out of fluid containers. In embodiments, the shelf assembly includes one or more racks that allow for placement of fluid containers in an inverted position. The shelf assembly further includes a collecting tray adjacent to (e.g., below) each rack to collect the fluids dripping out of the racks. The collecting tray discharges the fluids from the tray to a discharge station via outlets and/or connecting spouts. The discharge station allows for collection of the discharged fluids and subsequent disposal of the discharge. Such disposal is in accordance with EPA or other local regulations.

Using this shelf assembly, service stations are able to simply allow empty (or near-to-empty) fluid containers to be simply placed in the racks of the shelf assembly and then allow the fluid to slowly collect in the discharge station. The shelf assembly allows several containers to be placed at a single time, and in several configurable racks. In embodiments, the rack may be configured to allow placement of fluid containers by size and volume, as is discussed in detail in the accompanying detailed description. In some embodiments, the rack or collecting tray assembly may be operably connected with heating elements to allow accelerated or efficient flow of the fluids to the discharge station, especially in colder climate conditions. Further, in some embodiments, a discharge station is operably connected to electronic and communication equipment to enable an end-user to remotely monitor and be alerted of collection of fluids in the discharge station.

In these respects, the shelf assembly according to the present invention substantially departs from the conventional concepts and designs of the prior art. Other advantages and features will become apparent from the following description and claims. It should be understood that the description and specific examples are intended for purposes of illustration only and not intended to limit the scope of the present disclosure.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIGS. 1-2 illustrate views of an exemplary embodiment of a multi-rack shelf assembly that allows for efficient collection of fluid drainage;

FIG. 3 illustrates an exemplary embodiment of a multi-rack shelf assembly, where the rack is open or “slidable”; and

FIG. 4 illustrate a view of an exemplary embodiment of a single-rack shelf assembly that allows for efficient collection of fluid drainage.

### DETAILED DESCRIPTION OF THE INVENTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

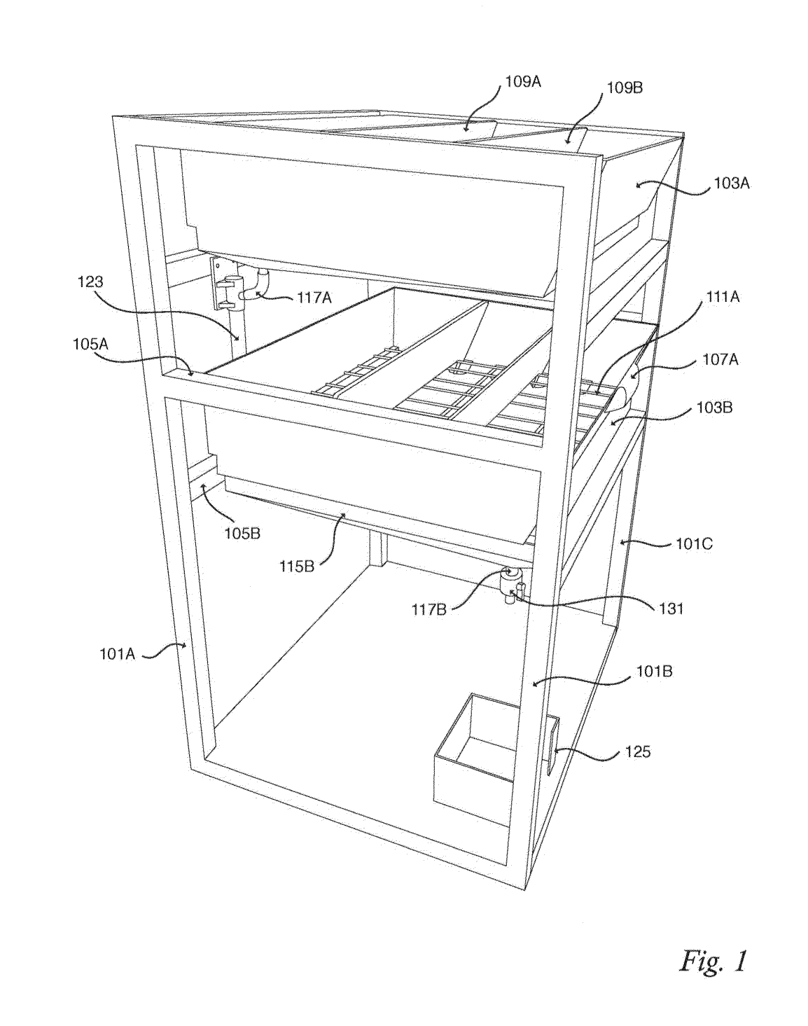

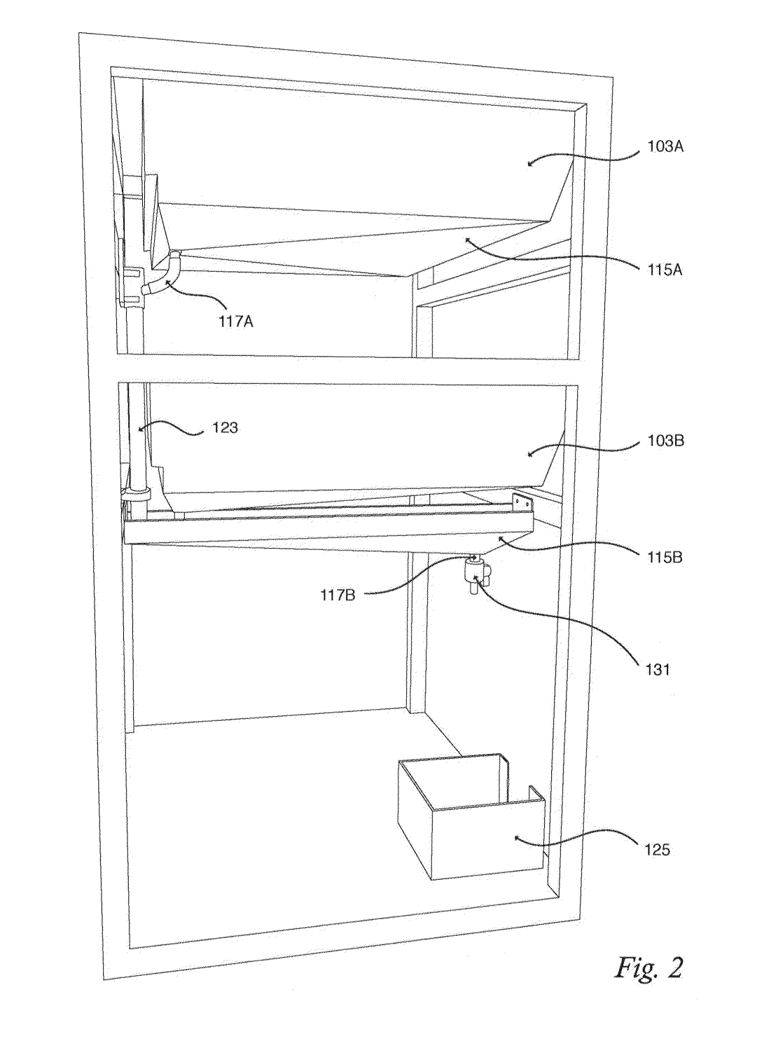

A shelf arrangement for fluid drainage is now explained in detail. FIGS. 1-2 illustrate various views of a first, embodiment of such a shelf arrangement. It is understood that this first embodiment is an exemplary illustration, and that, other modifications (e.g., in terms of number of racks included, placement of various rack and drainage features, positional arrangements, etc.), as may be apparent to one of ordinary skill in the art, are included variations of the techniques described herein.

In a first embodiment, as illustrated in FIGS. 1 and 2, the shelf arrangement 100 includes a plurality of support beams (e.g., 101A, 101B, 101C, etc.). These support beams provide essential support for the various racks and collecting trays that are placed in the shelf arrangement. It is understood that while the illustrated figures show four cylindrical shaped beams, any number of beams, in any shape or contour so as to be able to provide support to the racks and/or collecting trays, is encompassed within the techniques described herein. The materials used for the various components of the shelf arrangement may include, without limitation, one or more of plastic, wood, glass, fiber glass, composite materials, steel or other metal, etc.

The shelf arrangement 100 allows for placement of one or more racks (e.g., 103A, 103B, etc.). While the illustration of FIGS. 107 show multiple racks placed in the shelf arrangement 100, it is envisioned that the shelf arrangement may also be constructed using a single rack. In embodiments, each rack (e.g., 103A) is coupled or connected to the support beams by means of support rails (e.g., 105A, 105B, etc.). In some instances, the rack 103A may be immovably fixed to the support rails (e.g., by being crewed or clamped or fastened by other means to the support rails).

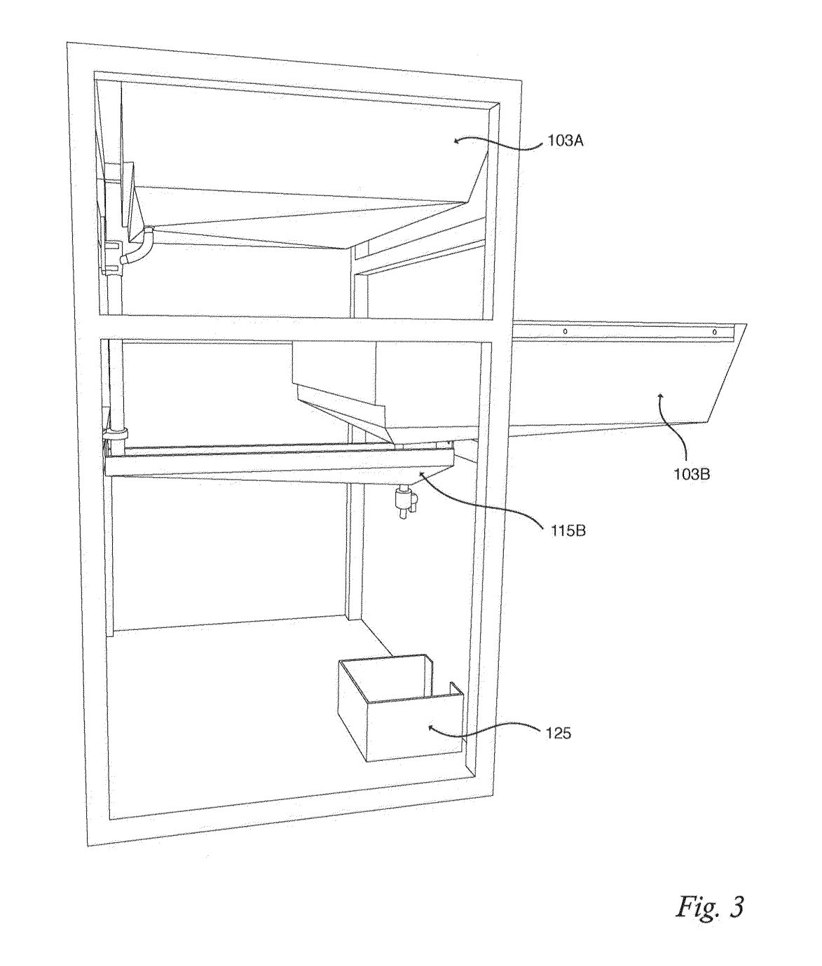

In some instances, as illustrated in FIG. 3, the rack 103B may be placed in conjunction with the support rails and the support beams such that the rack may be “slided” in and out for the convenience of an end-user. For example, the rack may be configured in a cabinet-drawer type of arrangement, where a user could simply pull out the rack 103B outside of the shelf arrangement by, for example, using a handle (e.g., 107A, FIG. 1) attached to the rack.

In some embodiments, the support beams are configured such that the end-user may selectively fit a given number of racks in the shelf arrangement. For example, the user may selectively install four shelves as needed or just remove three and live with one shelf depending on the demand of the day. Of course, it is understood that with each shelf removed, the user would have to configure the collecting trays and outlets at each level such that the connection to the discharge station is intact. These features are explained in further detail herein.

In embodiments, the rack allows for one or more fluid containers (e.g., engine oil containers, coolant liquid containers, etc.) to be placed in an inverted position to allow the fluid contents of the containers to be drained out. In some embodiments, the rack may optionally include multiple rack partitions (e.g., 109A, 109B, etc.). In some instances, each partition 109A may be placed at predefined positions of the rack so as to allow prescribed containers in ensuing spaces. For example, a rack 103A may be partitioned into three compartments of varying widths by means of two rack partitions. The first ensuing compartment has a width so as to snugly fit in 1-quart engine oil containers that have a specific shape and size). The second ensuing compartment has a width so as to snugly fit in 5-quart containers, and so on.

In some embodiments, the partitions are not permanently attached to the racks. Instead, they may be fastened (e.g., using clamping clips or strap on provisions) at will at various locations of the rack 103A such that the user can define compartment spaces at will depending on the need. Also, it may be envisioned that lateral and longitudinal compartment racks may be used to further allow a user to better configure the rack space at will.

In embodiments, a bottom surface 111A of the rack 103A is such that it allows fluids or other “flowable” materials to permeate or pass through. In one example, the bottom surface may just an arrangement of rods or wires with openings wide enough to allow fluids to permeate through, but narrow enough to allow containers to be placed on top. In some instances, the bottom surface 111A may just be a metal or plastic sheet with strategic or randomly placed perforations to allow fluids to flow through. Any other variations of such a bottom surface, as may be envisioned by a person of ordinary skill in the art, are understood to be equivalent variations thereof.

The fluid permeating or flowing out of the bottom surface 111A of the rack 103A collects in a collecting tray (e.g., 115A, 1158, etc.) located below the rack 103A. The collecting tray is usually a non-porous surface that allows the fluids to collect and subsequently flow over to a next level (e.g., to a discharge station 125 or to a next level of collecting tray by means of a connecting spot 119, as will be explained in further detail below). In some instances, the collecting tray 115A has an inclined surface that allows fluids to flow over to an outlet 117A. Such an inclined surface is illustrated in the collecting tray 115E of FIG. 5. Further, as illustrated in FIG. 5, the collecting tray ends at an outlet 117A that allows fluids to be drained out to the next level.

In some embodiments, the collecting tray may be connected to the support beams. In other embodiments, the collecting tray may simply be suspended from or supported by the racks. Other variations, as may be envisioned by a person of ordinary skill in the art, are also understood to be equivalent variations of the techniques discussed herein.

In some instances, for example in the scenario of FIGS. 1-3 where multiple racks are used, the outlet 117A may just connect to the outlet 117B of another collecting tray 115F by means of, for example, a connecting spout 123. In some instances, the outlets may all be in one side of the shelf arrangement, allowing the spout 123 to also just run along one side connecting to the various outlets. In some instances, the outlets of at each level may be at an opposite end to the outlet of the previous or subsequent level. Such an optional arrangement may be for the purpose of aesthetics, or even for the purpose of allowing fluids to have more flowing time in the collecting trays before they reach the discharge station. Such a configuration may be desired when the end-user wishes not to be hassled with frequent clearing of the contents of the discharge station.

In any event, in such a scenario, the connecting spout 123 may simply crisscross across the ends of the shelf arrangement. Alternately, two connecting spouts may be used at either end, with both spouts connected at the end or simply independently discharging fluids at the discharge station. Other such obvious variations of collecting trays, outlets, and spout arrangements, as may be envisioned by a person of ordinary skill in the art, are considered equivalent variations hereof.

In embodiments, each outlet 117A (or in some cases, just the last outlet in a multi-level collecting tray scenario) may be fitted with a tap mechanism e.g., 131). Here, the tap mechanism has two operating states—a locked state and an unlocked state. The locked state prevents fluids from the collecting tray to be discharged to a next level of the collecting tray. In the unlocked state, the tap mechanism allows the fluids collected in the collecting tray to be discharged to the next level of collecting trays. The tap mechanism may be, for example, any mechanism that allows control of flow of water, including mechanical, electric, or electronic means, or a combination thereof, as may be envisioned by a person of ordinary skill in the art.

In some embodiments, the collecting tray 115A and/or the rack 103A is operatively connected to a heating mechanism. For example, heating rods (not shown in the Figures) may be placed under the rack and/or collecting trays. In other examples, other sources of heat may be directly or operably connected to the rack and/or the collecting tray as may be envisioned by a person of ordinary skill in the art. This optional feature may be used, for example, in colder locations to facilitate an easier or accelerated flow of the fluids from the fluid containers, out of the bottom surface of the racks, and through the collecting trays to the outlets.

In embodiments, the shelf arrangement includes a discharge station 125. In the illustration of FIGS. 1-3, the discharge station 125 illustrates a three-walled structure that is located below either the last outlet of the collecting trays or the discharge end of the connecting spout, as the case may be. In the illustrated embodiment, the discharge station allows a discharge container (not shown in FIGS. 1-7) to be placed for collecting the fluids that are discharged via the collecting trays. In alternate embodiments, the discharge station itself could be configured as a removable container, or a fixed container with a tap arrangement to further discharge the fluids to an external container. In this manner, the fluids the collect from all the fluid containers are slowly accumulated into a discharge container that can effectively be disposed off in a manner that is complaint with local regulations (e.g., FDA).

In some embodiments, the discharge station may be fitted with an electric or electronic sensor to monitor the amount of fluids collected via the discharge station. For example, the discharge station may be operably connected to a pressure or other such sensor to monitor a weight of fluids collected via the discharge station 125.

In some instances, an electronic communication component (e.g., a wireless transmitter) may also be operably connected to the discharge station 125 to enable messages to be transmitted to an end-user. In some instances, the wireless component monitors a level (e.g., weight or volume) of the amount of fluids via the discharge container. The wireless component may interact with a local server, wireless modem, or a telecommunications network (or similar variants thereof) to send a message to a subscribed user. In some instances, for example, an end-user may receive a text message indicating that a certain threshold has been reached relating to collection via the discharge station 125, and accordingly signal the end-user replace a discharge container or perform other suitable actions. Again, these are only illustrative scenarios and other scenarios that allow various electronic components to be attached for allowing remote monitoring of various metrics associated with the discharge of the fluids in the discharge station 125.

The operable connections of the various electronic sensors and wireless communication mechanisms may be connected in any manner as may be understood by a person of ordinary skill in the art. Other variations, as may also be envisioned by a person of ordinary skill in the art, are also understood to be equivalent variations of the techniques discussed herein.

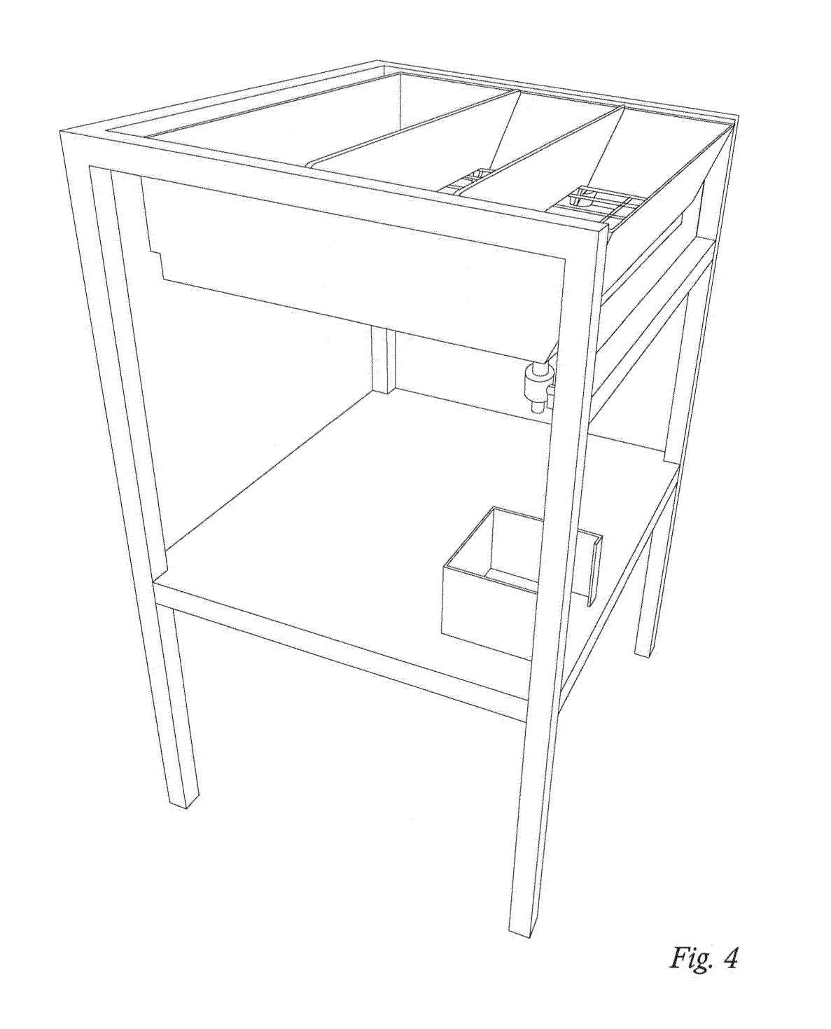

The above description illustrated an exemplary embodiment of a shelf assembly having multiple racks. FIG. 4 illustrates another exemplary embodiment, where a single rack is used, with similar functionalities as described above in reference to FIGS. 1-3. Of course, it is understood that these figures illustrate only exemplary embodiments, and other variations such illustrations, as may be envisioned thereof by a person of ordinary skill in the art, are considered equivalent variations of the above illustrated techniques.

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

What is claimed is:

1. A shelf assembly, comprising:
a plurality of support beams;
a rack supported by the plurality of support beams, a base surface of the rack configured to allow fluids to drain through said base surface, the rack further configured to allow placement of at least one fluid container over the base surface;
a collecting tray located below the base surface of the rack, the collecting tray configured to collect fluids draining out of the rack through the base surface; and
an outlet connected to the collecting tray, the outlet configured to enable discharge of fluids from the collecting tray.

2. The shelf assembly of claim 1, further comprising:
a discharge collection station, said discharge collection station located in proximity to the outlet connected to the collecting tray, said discharge collection station to enable collection of fluids discharged from the collecting tray.

3. The shelf assembly of claim 2, wherein the discharge collection station is a dedicated space located below the collecting tray to enable discharge containers to be placed for collecting fluids from the collecting tray.

4. The shelf assembly of claim 2, wherein the discharge collection station is a removable discharge container located below the outlet of the collecting tray.

5. The shelf assembly of claim 2, wherein the discharge collection station is operably connected to a sensor for sensing a function related to a volume of fluid connected via the discharge collection station.

6. The shelf assembly of claim 5, wherein the sensor is a pressure sensor to detect an amount of fluid collected in association with the discharge collection station.

7. The shelf assembly of claim 5, wherein the discharge collection station is further operably connected to a notification mechanism, the notification mechanism for sending a notification regarding a status of collection of fluids in association with the discharge collection station.

8. The shelf assembly of claim 7, wherein the notification mechanism is a light indicator indicating a level of collection of discharge in association with the discharge collection station.

9. The shelf assembly of claim 7, wherein the notification mechanism is a wireless transmitter, the transmitter configured to relay a status indicating a level of collection of discharge in association with the discharge collection station.

10. The shelf assembly of claim 9, wherein the relayed status is received as a message to a wireless device associated with a user.

11. The shelf assembly of claim 1, wherein the outlet includes a tap arrangement, the tap arrangement having a locked state and an unlocked state during operation, the locked state preventing fluids from discharging out of the collecting tray, and the unlocked state enabling fluids to be discharged out of the collecting tray.

12. The shelf assembly of claim 1, wherein the collecting tray is supported by at least one of the plurality of support beams.

13. The shelf assembly of claim 1, wherein the collecting tray is supported by the rack.

14. The shelf assembly of claim 1, further comprising:
an additional rack, the additional rack supported by the plurality of beams, a corresponding base surface of the additional rack configured to allow fluids to drain through said corresponding base surface, the additional rack further configured to allow placement of at least one fluid container over the corresponding base surface;
an additional collecting tray located below the corresponding base surface of the additional rack, the additional collecting tray configured to collect fluids draining out of the additional rack through the corresponding base surface; and
an additional outlet connected to the additional collecting tray, the additional outlet to enable discharge of fluids from the additional collecting tray.

15. The shelf assembly of claim 14, wherein the combination of the additional rack and the additional collecting tray is located above or below the combination of the rack and the collecting tray.

16. The shelf assembly of claim 15, further comprising a connector spout connecting the outlet and the additional outlet.

17. The shelf assembly of claim 16, wherein the connector spout further extends to an area proximate to a discharge collection station.

18. The shelf assembly of claim 17, wherein the connector spout includes a tap arrangement, the tap arrangement having a locked state and an unlocked state during operation, the locked state preventing fluids from discharging out of the collecting tray and the additional collecting tray, and the unlocked state enabling fluids to be discharged out of the collecting tray and the additional collecting tray.

19. The shelf assembly of claim 1, wherein the rack is selectively slidable apart from the plurality of support beams.

20. The shelf assembly of claim 1, wherein at least one of the rack or the collecting tray is operably coupled to a heating source to enable accelerated drainage of fluids via the collecting tray.
